(19) United States
(12) Patent Application Publication
(10) Pub. No.: US 2021/0362423 A1
(43) Pub. Date: Nov. 25, 2021

(54) MOISTURE CONTENT ADJUSTMENTS IN BUILD MATERIAL TRANSPORT PATHS

(71) Applicant: HEWLETT-PACKARD DEVELOPMENT COMPANY, L.P., Spring, TX (US)

(72) Inventors: Justin M Roman, Vancouver, WA (US); David R. Otis, Corvallis, OR (US); John Geile, Vancouver, WA (US); Luke P. Sosnowski, Vancouver, WA (US)

(21) Appl. No.: 16/607,755

(22) PCT Filed: Jul. 31, 2018
(86) PCT No.: PCT/US18/44680

§ 371 Date: Oct. 24, 2019

(51) Int. Cl. B29C 64/364; B29C 64/314; B29C 64/321; B29C 64/393; B33Y 10/00; B33Y 30/00; B33Y 40/10; B33Y 50/02

(52) U.S. Cl. CPC B29C 64/364; B29C 64/314; B29C 64/321; B33Y 50/02; B33Y 10/00; B33Y 30/00; B33Y 40/10; B29C 64/393

(57) ABSTRACT

An example of an apparatus is provided. The apparatus includes a build material transport path to transport a build material with air flow. The apparatus includes a humidifying element to receive the air flow and to add moisture to the air flow. The apparatus includes an inlet to introduce ambient air into the build material transport path to decrease moisture content in the air flow. The apparatus includes a valve to connect the humidifying element and the inlet to the build material transport path. The valve is to adjust an amount of ambient air introduced into the build material transport path. The apparatus includes a sensor to detect the moisture content in the air flow and to generate a signal to indicate the moisture content. The apparatus includes a processor to receive the signal to control the valve to maintain a moisture content in the air flow.

### BACKGROUND

Printing devices are often used to present information. In particular, printing devices may be used to generate output that may be easily handled and viewed or read by users. Accordingly, the generation of output from printing devices from electronic form continue to be used for the presentation and handling of information. Some printing devices deliver consumable build materials to components or subassemblies throughout the printing device. To transport build materials throughout the printing device, build material transport paths may be used where build materials may be carried through conduits using an air flow.

### BRIEF DESCRIPTION OF THE DRAWINGS

Reference will now be made, by way of example only, to the accompanying drawings in which:

FIG. 1 is a schematic representation of an example apparatus to manage moisture content in a pneumatic build material delivery system;

FIG. 2 is a schematic representation of another example apparatus to moisture content in a pneumatic build material delivery system;

FIG. 3a is a cross-section view of an example valve with a first plane;

FIG. 3b is a cross-section view of an example valve with a second plane perpendicular to the first plane; and

FIG. 4 is a flowchart of an example of a method of managing moisture content in a pneumatic build material delivery system.

### DETAILED DESCRIPTION

Three-dimensional (3D) printing may produce a 3D object by adding successive layers of build material, such as powder, to a build platform, then selectively solidifying portions of each layer under computer control to produce the 3D object. The build material may be powder, or powder-like material, including metal, plastic, ceramic, composite material, and other powders. In some examples the build material may be formed from, or may include, short fibers that may, for example, have been cut into short lengths from long strands or threads of material. The objects formed may be various shapes and geometries, and may be produced using a model, such as a 3D model or other electronic data source. The fabrication may involve laser melting, laser sintering, heat sintering, electron beam melting, thermal fusion, and so on. The model and automated control may facilitate the layered manufacturing and additive fabrication. The 3D printed objects may be prototypes, intermediate parts and assemblies, as well as end-use products. Product applications may include aerospace parts, machine parts, medical devices, automobile parts, fashion products, and other applications. Some printing devices use powders to generate output. In such printing devices, pneumatic build material delivery systems are generally used to deliver a powder from one part of the printing device, such as a hopper to a print head where output is generated. Large printing devices may have large and complex delivery systems for various build materials.

The build material may be a dry, or substantially dry, powder. In a three-dimensional printing example, the build material may have an average volume-based cross-sectional particle diameter size of between about 5 and about 400 microns, between about 10 and about 200 microns, between about 15 and about 120 microns or between about 20 and about 70 microns. Other examples of suitable, average volume-based particle diameter ranges include about 5 to about 70 microns, or about 5 to about 35 microns. As used herein, a volume-based particle size is the size of a sphere that has the same volume as the powder particle. The average particle size is intended to indicate that most of the volume-based particle sizes in the container are of the mentioned size or size range. However, the build material may include particles of diameters outside of the mentioned range. For example, the particle sizes may be chosen to facilitate distributing build material layers having thicknesses of between about 10 and about 500 microns, or between about 10 and about 200 microns, or between about 15 and about 150 microns. One example of a manufacturing system may be pre-set to distribute powdered material layers of about 80 microns using build material containers that include build material having average volume-based particle diameters of between about 40 and about 60 microns. An additive manufacturing apparatus may also be configured or controlled to form powder layers having different layer thicknesses.

As described herein, the build material may be, for example, a semi-crystalline thermoplastic material, a metal material, a plastic material, a composite material, a ceramic material, a glass material, a resin material, or a polymer material, among other types of build material. Further, the build material may include multi-layer structures wherein each particle comprises multiple layers. In some examples, a center of a build material particle may be a glass bead, having an outer layer comprising a plastic binder to agglomerate with other particles for forming the structure. Other materials, such as fibers, may be included to provide different properties, for example, strength.

When transporting build material, such as powders, through conduits using air flow, electrostatic charge may build up as particles rub against each other and the walls of the conduit during transport. This may cause the particles to bond with the walls of the conduit, other particles, or components in the pneumatic build material delivery system. For example, electrostatic buildup may cause particles to clog valves, blowers, venturis, and other components to reduce the performance of these components or to cause a failure.

To reduce the amount of electrostatic buildup, humidity is introduced into the air used to move the build material, such as powder, through the pneumatic build material delivery system. However, adding too much humidity may cause condensation in the pneumatic build material delivery system and powder clumping, both of which may result in the reduced performance of the pneumatic build material delivery system. Each powder may have a target humidity range within which the powder may be transferred efficiently. Therefore, humidity is to be added to the pneumatic build material delivery system with a humidifying element. In general, pneumatic build material delivery systems are operated as negative pressure systems such that build material, such as powder, does not escape from the pneumatic build material delivery system which may cause dust to collect in the vicinity of the printing device. Accordingly, in closed systems, once humidity increases it may be difficult to lower the absolute humidity, also known as the dew point. Some systems may include heaters to mitigate clumping of powder in the pneumatic build material delivery system and to avoid condensation by increasing the temperature above the dew point. However, as the humidifying element introduces more moisture, the temperature of the pneumatic build material delivery system may be increased to temperatures that may cause damage to other components of the printing device.

An alternative to increasing the temperature of the pneumatic build material delivery system may be to operate an open system where the airflow in the pneumatic build material delivery system is not recirculated and instead is used once. In such systems, fresh ambient air passes through the humidifying element to deliver the build material in the printing device and then exhausted back into the ambient atmosphere. It is to be appreciated that in such systems, a more accurate dew point range may be achieved. However, the energy costs used to warm the air entering the pneumatic build material delivery system as well as to operate the humidifying element may be significantly higher than for closed loop systems. Also, the use of consumable water may be higher for an open system, leading to more interventions.

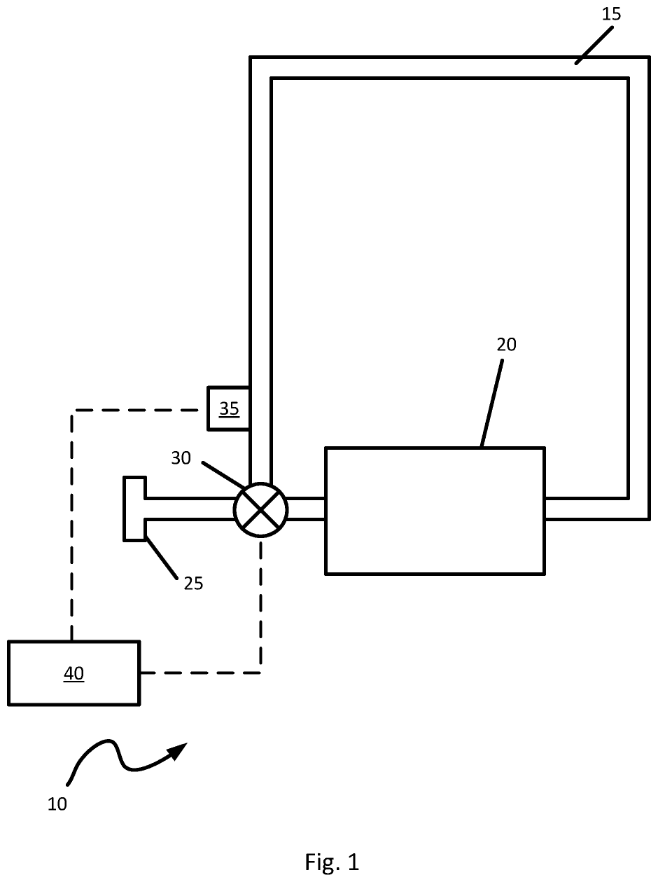

Referring to FIG. 1, an apparatus to manage the moisture content in a pneumatic build material delivery system is shown at 10. The apparatus 10 may be a part of the printing device or a separate component to operate on the printing device to deliver build material from an external source to the printing device. The apparatus 10 may include additional components, such as various additional interfaces and/or displays to interact with a user or administrator of the apparatus, such as to monitor and control various components of the printing device. In the specific example, the apparatus 10 is to operate a pneumatic build material delivery system within the printing device by taking build material, such as powder, from one location, such as a storage hopper (not shown), to another location, such as a print head (not shown) where the build material is to be used to generate output. In the present example, the apparatus 10 includes a build material transport path 15, a humidifying element 20, an inlet 25, a valve 30, a sensor 35, and a processor 40.

The build material transport path 15 is to transport powder with air flow. In the present example, the build material transport path 15 includes conduits extending from the valve 30 to the humidifying element 20. In the present example, air enters the build material transport path 15 via an outlet of the valve 30 and flows through the conduit to various components of the printing device. The air eventually reaches the humidifying element 20 and may be recirculated back to the valve 30 to re-enter the build material transport path 15. The conduits used to move the air through the build material transport path 15 may be a flexible tube, such as a metal, plastic, or rubber tube. The interior of the tube may be made of a conductive material such as conductive silicone or coated with a conductive material to facilitate the transport of powder by reducing the likelihood of powder sticking to the interior walls, and to reduce electrostatic charge buildup.

It is to be appreciated that as the air moves through the build material transport path 15, the air may pass through components (not shown) that add build material, such as powder, to the air flow or extract build material, such as powder, from the air flow. For example, the air may pass through a hopper storing powder to be used at a print head. As the air enters a hopper, powder may be mixed with the air before the air exits the hopper and re-enters the build material transport path 15. The air and powder mixture continues along the build material transport path 15 until the powder is extracted from the mixture, such as at a spreading mechanism, where the powder may be used in the printing process. The manner by which the powder is extracted is not limited and may involve passing the air and powder mixture through a cyclone separator that removes the powder from the air flow, and filter to catch anything that the cyclone does not remove. In the present example, air originally extracted from the ambient atmosphere is used in the build material transport path 15. In other examples, another gas may be substituted, such as nitrogen, carbon dioxide, or another gas mix.

In the present example, the build material transport path 15 is operated at a negative pressure relative to the ambient atmosphere. It is to be appreciated that by operating the build material transport path 15 at a negative pressure, the powder being transported through the build material transport path 15 does not escape into the ambient atmosphere. For example, various joints or components, such as the hopper or print head may have small leaks. By having the build material transport path 15 at a negative pressure, the air and powder mixture does not leave the build material transport path 15. The manner by which the air is propelled through the build material transport path 15 is not limited. For example, the apparatus 10 may include a blower or compressor in the build material transport path 15. In other examples, a vacuum line may be used to draw air toward the vacuum source. In further examples, an external pressurized gas source may be used to propel the air through the build material transport path 15.

The humidifying element 20 is to receive the air flow from the build material transport path 15. In the present example, the humidifying element 20 is to add moisture to the air flow to provide moist air back into the build material transport path 15 via the valve 30. The manner by which the humidifying element 20 adds moisture to the air flow is not limited. For example, the humidifying element 20 may be a water bath over which the air flow is passed such that the air absorbs moisture from evaporation. In other examples, the humidifying element 20 may include a structure to increase the surface area to facilitate evaporation and add moisture to the air flow at a higher rate. For example, the humidifying element may include a porous material, a mister, or an ultrasonic droplet generator. In some examples, a heating element may be used as well to increase the rate at which moisture is added to the air flow.

In the present example, the inlet 25 is to introduce ambient air into the build material transport path 15 via the valve 30. It is to be appreciated that the ambient air generally has less moisture content (i.e. a lower dew point) that the moist air leaving the humidifying element 20. In particular, if the air flow were to circulate in a closed loop where each flow through the loop passes through the humidifying element 20, the dew point of the air flow will continue to increase with each pass of the loop. Therefore, the air flow will eventually have a moisture content that will cause issues with build material transport either due to condensation or clumping. It is to be appreciated that the target dew point is not particularly limited. For example, the target dew point may be set to be below ambient temperature such that no additional heating of the build material transport path 15 is used to reduce the likelihood of condensation. In other examples, the target dew point may be set to a value, such as 20 degrees Celsius. By introducing ambient air into the build material transport path 15, the moisture content in the air flow of the build material transport path 15 may be lowered and managed to achieve a target dew point or to maintain the moisture content (i.e. a dew point) within a predetermined range for powder transport.

The inlet 25 is not particularly limited and may involve any type of opening where ambient air may enter the apparatus 10. For example, the ambient air may be from an appropriate filtered air reservoir or source. In other examples, the inlet 25 may be an opening on a housing of the printing device that may or may not be filtered to prevent contaminants from entering the air flow. In further examples, the ambient air may be substituted with compressed air, dried air, or another gas.

The valve 30 is to connect the humidifying element 20 and the inlet 25 to the build material transport path 15. In the present example, the valve 30 is to allow for adjustments of the characteristics of the air to enter the build material transport path 15. In particular, the valve 30 may adjust the amount of ambient air received from the inlet 25 to be introduced into the build material transport path 15. As discussed above, the moist air leaving the humidifying element 20 and entering the valve 30 may have a dew point that is above a predetermined range. In this example, the valve 30 may introduce more ambient air into the build material transport path 15 to lower the dew point of the air flow. Once the dew point is within the predetermined range, the valve 30 may reduce or stop the ambient air from entering the build material transport path 15, such the humidifying element 20 may add more moisture to the air flow via multiple passes until the air in the build material transport path 15 reaches an upper limit for the dew point again.

The functionality of the valve 30 is not limited. For example, the valve 30 may be a ball valve to control whether ambient air may be added to the moist air from the humidifying element 20. In this example, the moist air leaving the humidifying element 20 may not be controlled such that ambient air may be added to the moist air. In this example, since the build material transport path 15 is maintained at negative pressure relative to ambient air, the opening of the valve 30 is sufficient to draw in air. In other examples, the ambient air may be introduced into the build material transport path 15 via a blower or compressor. The valve 30 may also include other types of valves, such as a needle valve to control the flow of the ambient air into the build material transport path 15.

In another example, the valve 30 may be a non-mixing valve to allow a single flow of air at a time. In this example, the valve 30 may be moveable between two positions. A first position may be to introduce ambient air into the build material transport path 15 without any moist air from the humidifying element 20. Continuing with this example, the valve 30 may be moveable to a second position to allow air flow from the humidifying element (i.e. moist air) to flow into the build material transport path 15.

The sensor 35 is to detect the moisture content in the air flow. In the present example, the sensor 35 may also generate a signal to indicate the moisture content of the air flow. For example, the signal may be a message communicated to the processor 40. In other examples, the sensor 35 may not generate any signals and simply provide a visual indication of the humidity of the air flow.

In the present example, the sensor 35 is a humidity sensor that provides a dew point of the air flow. The manner by which the sensor 35 determines the dew point is not limited. For example, the sensor 35 may determine a relative humidity using capacitive or resistive methods along with a temperature. The sensor 35 may use the values to determine the dew point of the air flow. In other examples, the sensor 35 may include separate temperature and relative humidity sensors and provide this information to the processor 40 where the processor 40 may calculate the dew point of the air flow.

The placement of the sensor 35 is not particularly limited and may be anywhere along the build material transport path 15 in this example. For example, the sensor 35 may be placed downstream of valve 30. In other examples, the sensor 35 may be placed between the humidifying element 20 and the valve 30 to determine the moisture content of the moist air, or upstream of the humidifying element 20. In further examples, additional sensors may be placed at various locations along the build material transport path 15, at the inlet 25, or between the humidifying element 20 and the valve 30 to determine the moisture content at various locations of the apparatus 10. Also, an additional sensor may be used to measure the ambient temperature to determine an appropriate target dew point.

The processor 40 may include a central processing unit (CPU), a microcontroller, a microprocessor, a processing core, a field-programmable gate array (FPGA), an application-specific integrated circuit (ASIC), or similar. The processor 40 may include a memory storage unit to store various instructions for execution. In particular, the processor 40 may execute instructions stored on the memory storage unit to carry out various functions and to manage the moisture in the air flow of the pneumatic build material delivery system. For example, the processor 40 may be used to implement an ongoing monitoring process to maintain the dew point at the sensor 35 within a predetermined range for acceptable build material transport.

In the present example, the processor 40 is to receive a signal from the sensor 35. The signal received from the sensor 35 is not particularly limited. In the present example, the signal includes raw data measured by the sensor 35. The raw data may include a temperature detected by the sensor 35 as well as a relative humidity measured by the sensor 35. Continuing with this example, the processor 40 analyzes the raw data to calculate a dew point of the air flow at the sensor 35. The processor 40 is to control the valve 30 by sending a control signal to the valve 30 to adjust the amount of ambient air to introduce into the build material transport path 15. For example, if the dew point calculated by the processor 40 exceeds the predetermined range for operation, the processor 40 will open the valve 30 to ambient air to maintain the predetermined moisture content in the air flow by introducing the drier ambient air via the inlet 25.

The operation of the processor 40 is not limited. For example, the sensor 35 may be more sophisticated and include a separate microprocessor or other processing devices to calculate a dew point. In this example, the dew point may be provided to the processor 40 such that a decision on whether to send a control signal to the valve 30 may be made more quickly. In another example, the sensor 35 may provide the processor with a control command for the valve 30. In other words, the sensor 35 may carry out the calculation and make the determination prior to sending any signal to the processor 40, which controls the valve.

The monitoring process of the moisture content is not limited and may involve monitoring periodic signals from the sensor 35 to determine the dew point of the air flow. In other examples, the monitoring process may involve detecting a signal from the sensor 35 indicating a dew point that is outside of the operational range.

It is to be appreciated that variations to the apparatus 10 are contemplated. For example, in some examples, the sensor 35 may be omitted. Instead, the humidity in the build material transport path 15 may be estimated based on the quality of the output generated by the printing device. For example, the output may exhibit certain characteristics when the build material transport path 15 is too moist and other characteristics when the build material transport path 15 is too dry. Upon observation of these characteristics, adjustments may be made by adjusting the valve 30. As another variation, the processor 40 may also be omitted in examples where an operator monitors a readout of the sensor 35 and makes manual adjustments of the valve 30.

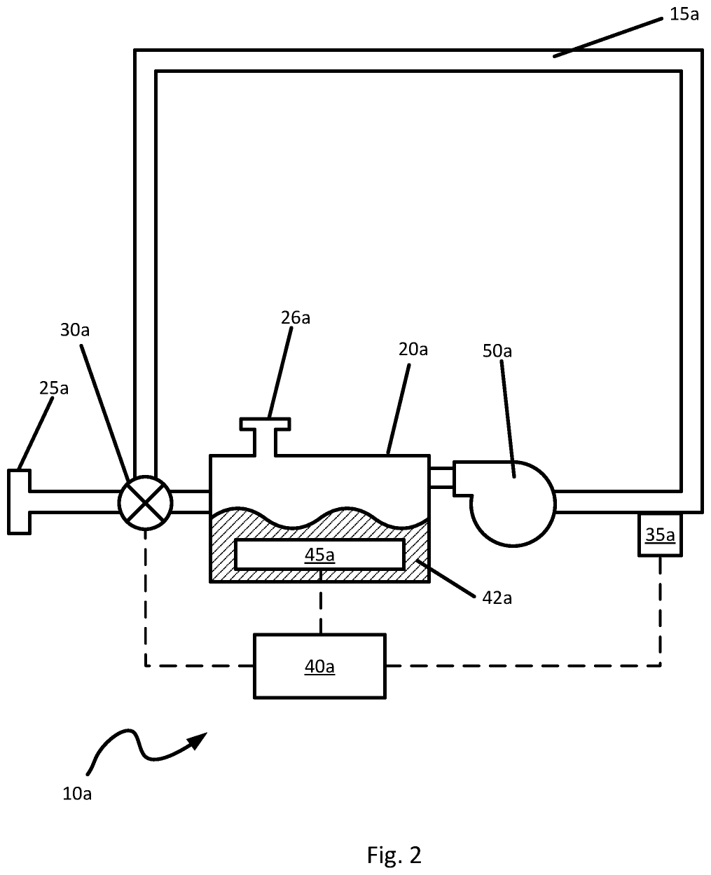

Referring to FIG. 2, another example of an apparatus to manage the moisture content in a pneumatic build material delivery system shown at 10a. Like components of the apparatus 10a bear like reference to their counterparts in the apparatus 10, except followed by the suffix “a”. The apparatus 10a may include additional components, such as powder feeders, separation system, filters, various additional interfaces and/or displays to interact with a user or administrator of the apparatus, such as to monitor and control various components of the printing device. The apparatus 10a includes a build material transport path 15a, a humidifying element 20a having a heating element 45a, an inlet 25a, an overflow outlet 26a, a valve 30a, a sensor 35a, a processor 40a, and a blower 50a.

The build material transport path 15a is to transport powder with air flow. In the present example, the build material transport path 15a includes conduits extending from the valve 30a to the blower 50a. In the present example, air enters the build material transport path 15a via an outlet of the valve 30a and flows through the conduit to various components of the printing device. The air eventually reaches the blower 50a and to be recirculated via the humidifying element 20a back to the valve 30a and to re-enter the build material transport path 15a. Along the build material transport path 15a, powder may be introduced at a feeder (not shown) and removed by a cyclone or filter (not shown) before returning to the blower 50a.

In the present example, the blower 50a is to circulate the air flow through the build material transport path 15a. The blower 50a is not particularly limited and may be device capable of moving air through the build material transport path 15a. In the present example, the blower 50a is located proximate to the humidifying element 20a to provide negative pressure in the portion of the build material transport path 15a carrying the powder. In other examples, the blower 50a may be located at another position on the build material transport path 15a such as proximate to the valve 30a or anywhere therebetween. In further examples, the blower 50a may be disposed between the humidifying element 20a and the valve 30a.

In the present example, the humidifying element 20a is to receive the air flow from the build material transport path 15a. In the present example, the humidifying element 20a is to add moisture to the air flow to provide moist air back into the build material transport path 15a via the valve 30a. In the present example, the humidifying element 20a includes a water source 42a, such as a water bath, and a heating element 45a. In the present example, the heating element 45a is in communication with the processor 40a to receive control commands to control the amount of energy that the heating element 45a is to add to the water source. The heating element 45a is not particularly limited and may be a resistive heating element, a heat pump, peltier device, or a thermoelectric heater.

In other examples, the heating element 45a is may not be connected to the processor 40a and instead be self-regulated to maintain the water source 42a at a predetermined temperature. In further examples, the heating element 45a may be manually controlled by an operator. For example, the output generated by the printing device may exhibit certain characteristics when the build material transport path 15a is too moist and other characteristics when the build material transport path 15a is too dry. Upon observation of these characteristics, adjustments may be made by adjusting power of the heating element 45a to control the amount of moisture and the dew point of the air flow.

It is to be appreciated that the heating element 45a may be another variable to be used in combination with the valve 30a to control the moisture level of the air flow. By raising or lowering the moisture level, the dew point of the air flow may be maintained within a predetermined range for powder transport.

Furthermore, it is to be appreciated that the blower 50a may add energy to the system and act as an addition heating element that is to be considered when adjusting the heating element 45a. In some examples, the blower 50a may generate sufficient heat such that the heating element 45a may be omitted and that the heat generated from the blower 50a may be sufficient to heat the water source 42a to provide sufficient moisture to the build material transport path 15a.

In the present example, the valve 30a is to connect the humidifying element 20a and the inlet 25a to the build material transport path 15a. The valve 30a is to allow for adjustments of the characteristics of the air to enter the build material transport path 15a. In this example, the valve 30a is a mixing valve to adjust and combine ambient air received from the inlet 25a and moist air (i.e. air flow from the build material transport path 15a with added moisture) from the humidifying element 20a. The manner by which the valve 30a mixes the ambient air and the moist air is not particularly limited and will be discussed in greater detail below. The air mixture is then to be dispensed through the build material transport path 15a. As discussed above, the moist air leaving the humidifying element 20a and entering the valve 30a may have a dew point that is above a predetermined range. In this example, the valve 30a mix some ambient air with the moist air to lower the dew point of the air flow dispensed into the build material transport path 15a. Furthermore, as ambient air enters the build material transport path 15a during operation, more air may be added to the system which may lead to an increase in the pressure of the build material transport path 15a relative to the ambient pressure. Accordingly, the overflow outlet 26a connected to the humidifier may be used to remove excess air from the build material transport path 15a.

In the present example, the processor 40a is to receive a signal from the sensor 35a. The signal may include raw data measured by the sensor 35a. The raw data may include a temperature detected by the sensor 35a as well as a relative humidity measured by the sensor 35a. The processor 40a analyzes the raw data to calculate a dew point of the air flow at the sensor 35a. In the present example, the processor 40a is to control the valve 30a by sending a control signal to the valve 30a to adjust the amount of ambient air to introduce into the build material transport path 15a. In addition, the processor 40a is to control the heating element 45a to adjust the rate at which moisture is added to the air flow in the humidifying element 20a. For example, if the dew point calculated by the processor 40a exceeds the predetermined range for operation, the processor 40a will open the valve 30a to ambient air and decrease the amount of energy supplied by the heating element 45a to maintain the reduce the moisture content in the air flow. Conversely, if the dew point calculated by the processor 40a is below the predetermined range for operation, the processor 40a will open the valve 30a to ambient air and decrease the amount of energy supplied by the heating element 45a to maintain the reduce the moisture content in the air flow

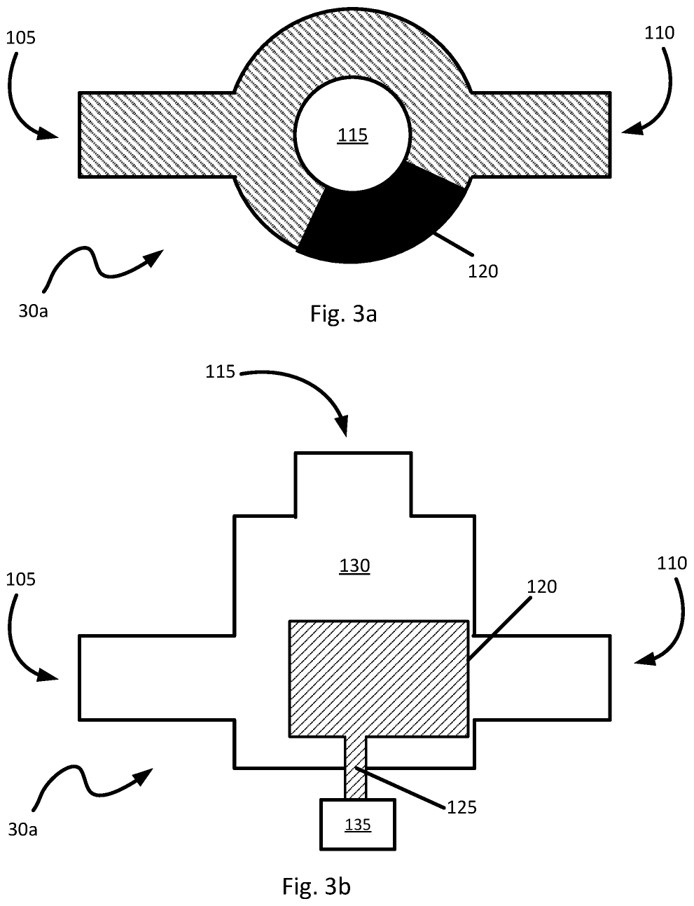

Referring to FIGS. 3a and 3b, an example of a valve 30a is shown in greater detail from two different cross sections perpendicular to each other. In the present example, the valve 30a is a three-port mixing valve. In the present example, the valve 30a includes two inlets 105 and 110, an outlet 115, a moveable element 120 mounted on a post 125, a mixing chamber 130, and motor 135.

In the present example, the inlet 105 is to receive ambient air. For example, the inlet 105 may be connected to the inlet 25a from which ambient air may be provided. In other examples, the inlet 105 may be the same as the inlet 25a.

The inlet 110 is to receive moist air from the humidifying element 20a. In the present example, the humidifying element may add moisture to air received from the build material transport path 15a. Furthermore, it is to be appreciated that the moist air from the humidifying element 20a has greater moisture content the ambient air. Therefore, mixing the moist air with the ambient air will reduce the moisture content of the air dispensed into the build material transport path 15a.

The outlet 115 is to dispense the ambient air from the inlet 105 and the moist air from the inlet 110 into the build material transport path 15a. The outlet 115 is not particularly limited and various designs are contemplated. For example, the outlet 115 may be oriented perpendicular to the inlet 105 and the inlet 110. It is to be appreciated that in this configuration, since the flow of ambient air from the inlet 105 and the flow of the moist air from the humidifying element 20a is to change directions by 90 degrees, more turbulence is generated to provide for more thorough mixing of the ambient air with the moist air. In examples where the inlet 105 and the inlet 110 are opposite each other, the streams air received by the inlet 105 and the inlet 110 will collide to cause even more turbulence to provide additional mixing in the mixing chamber 130 prior to being dispensed via the outlet 115 to the build material transport path 15a.

The moveable element 120 is to adjust the ratio of ambient air and moist air from the humidifying element. In the present example, the moveable element is to block a inlet to control the ratio of ambient air and moist air. Accordingly, the moveable element 120 may be moveable between the inlet 105 and the inlet 110 such that the moveable element 120 has sufficient range and capability to over one of the inlet 105 and the inlet 110. However, it is to be appreciated that the moveable element 120 may be positioned to partially block either the inlet 105 and the inlet 110. By partially blocking one of the inlet 105 and the inlet 110, the ratio of ambient air to moist air may be accurately controlled to achieve a target dew point for the air in the build material transport path 15a.

In the present example, the valve 30a also includes a motor 135 connected to the moveable element 120 via a post 125. The motor 135 is to move the moveable element 120 to a target position. The manner by which the motor 135 moves the moveable element 120 is not limited. In the present example, the moveable element 120 is rotatably connected relative to the housing of the valve 30a. Accordingly, the motor 135 may be used to rotate the moveable element 120 from a first position to a second position. In other examples, the moveable element 120 may be moved without a motor 135, such as manually or via another adjustment mechanism.

Furthermore, in the present example, the motor 135 is to receive a control signal from the processor 40a. The control signal may be to move the moveable element 120 to adjust the ratio of ambient air to moist air to maintain a predetermined moisture content (i.e. air with a target dew point) within the build material transport path 15a.

It is to be appreciated that variations to the apparatus 10a are contemplated. For example, although the discussion relates to a system where the air flows in a clockwise direction as view in FIG. 2, the air flow may be reversed in other examples. In this regard, the ambient air may be introduced prior to entering the humidifying element 20a instead of prior to entering the build material transport path 15a. Accordingly, it follows that the direction of the blower 50a is also to be reversed in this example.

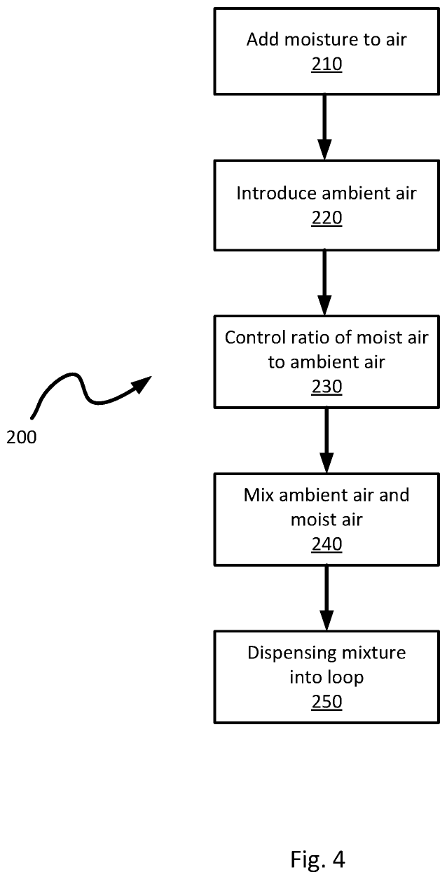

Referring to FIG. 4, a flowchart of a method to manage moisture content in a pneumatic build material delivery system is shown at 200. In order to assist in the explanation of method 200, it will be assumed that method 200 may be performed with the apparatus 10a. Indeed, the method 200 may be one way in which apparatus 10a may be configured. Furthermore, the following discussion of method 200 may lead to a further understanding of the apparatus 10a and its various components. Furthermore, it is to be emphasized, that method 200 may not be performed in the exact sequence as shown, and various blocks may be performed in parallel rather than in sequence, or in a different sequence altogether.

Block 210 involves the humidifying element 20a adding moisture to air flow from the build material transport path 15a to generate moist air. The manner by which moisture is added is not limited. In the present example, the humidifying element 20 includes a water source 42a that is heated with a heating element 45a. The air flow is then blown over the water source 42a to collect moisture before leaving the humidifying element 20a as moist air.

In block 220, ambient air is introduced into the build material transport path 15a. The ambient air enters the valve 30a from the inlet 25a. As discussed above, the ambient air generally has a lower moisture content than the moist air leaving the humidifying element and may be used to lower the moisture content of the air flow through the build material transport path 15a.

Block 230 involves controlling the ratio of moist air to ambient air entering the valve 30a. The ratio of moist air to ambient air may be adjusted to maintain a predetermined moist content in the build material transport path 15a. In the present example, a sensor 35a may be used to detect moisture content in the build material transport path 15a. The moisture content detected may be compared against a target moisture content or a range of moisture content. In this example, the valve 30a may then be used to control the ratio in response to the detected moisture content if the reading with not within the predetermined range.

The manner by which the ratio is controlled is not limited. In the present example, the valve 30a includes a moveable element 120 which may be positioned using a motor 135 to partially cover one of the inlet 105 or the inlet 110. It is to be appreciated that by partially blocking the inlet 105 or the inlet 110, the ratio of moist air to ambient air may be controlled. In other examples, the valve 30a many include independent sub-valves that control the flow of the moist air and the ambient air. In this example, each sub-valve may be independently controlled to provide the targeted ratio.

Block 240 comprises mixing the ambient air introduced via the inlet 25a with the moist air received from the humidifying element 20a to form a mixture of air. The manner by which the ambient air and the moist air is mixed is not limited. In the present example, the ambient air and the moist air is mixed by turbulence generated as the ambient air and the moist air enters the mixing chamber 130 and moves toward the outlet 115. In some examples, baffles or mixing devices, such as propellers, may be included in the mixing chamber 130 to further facilitate mixing of the ambient air and the moist air.

After the air is sufficiently mixed in block 240, the air mixture is dispensed into the build material transport path 15a via the outlet 115 of the valve 30a. As the air flow moves through the build material transport path 15a, the mixture will reach the humidifying element 20a where moisture is added to the air flow. The cycle then repeats itself to maintain a moisture content within a predetermined range.

It should be recognized that features and aspects of the various examples provided above may be combined into further examples that also fall within the scope of the present disclosure.

What is claimed is:

1. An apparatus comprising:
a build material transport path to transport a build material with air flow;
a humidifying element to receive the air flow from the build material transport path, the humidifying element to add moisture to the air flow;
an inlet to introduce ambient air into the build material transport path to decrease moisture content in the air flow;
a valve to connect the humidifying element and the inlet to the build material transport path, wherein the valve is to adjust an amount of ambient air introduced into the build material transport path;
a sensor to detect the moisture content in the air flow and to generate a signal to indicate the moisture content; and
a processor to receive the signal from the sensor and to control the valve to maintain a predetermined moisture content in the air flow.

2. The apparatus of claim 1, wherein humidifying element comprises a water source and a heating element.

3. The apparatus of claim 2, wherein the processor is to control the heating element to adjust a rate at which moisture is added to the air flow.

4. The apparatus of claim 1, further comprising a blower to circulate the air flow through the build material transport path.

5. The apparatus of claim 1, wherein the valve is a mixing valve to combine a mixture of the ambient air and the air flow from the humidifying element.

6. The apparatus of claim 5, further comprising a moveable element in the mixing valve, the moveable element to adjust a ratio of the ambient air and moist air from the humidifying element.

7. The apparatus of claim 1, wherein the valve is a non-mixing valve moveable between a first position to introduce the ambient air into the build material transport path and a second position to allow moist air from the humidifying element to flow into the build material transport path.

8. A valve comprising:
a first inlet to receive ambient air;
a second inlet to receive moist air from a humidifying element, wherein the humidifying element adds moisture to air from a build material transport path, wherein the moist air has greater moisture content than the ambient air;
an outlet to dispense the ambient air received from the first inlet and the moist air received from the second inlet into the build material transport path; and
a moveable element moveable between the first inlet and the second inlet, wherein the moveable element is to adjust a ratio of the moist air to the ambient air to maintain a predetermined moisture content in the build material transport path.

9. The valve of claim 8, the outlet is oriented perpendicular to the first inlet and the second inlet.

10. The valve of claim 8, further comprising a motor to move the moveable element.

11. The valve of claim 10, wherein motor to receive a control signal from a processor, wherein the control signal is to move the moveable element to adjust the ratio to maintain a predetermined moisture content in the build material transport path.

12. A method comprising:
adding moisture, with a humidifying element, to air flow received from a build material transport path to generate moist air;
introducing ambient air into the build material transport path via an inlet, wherein the ambient air has a lower moisture content than the moist air;
controlling a ratio of the moist air to the ambient air to maintain a predetermined moisture content in the build material transport path;
mixing the ambient air introduced via the inlet with the moist air from the humidifying element to form a mixture; and
dispensing the mixture into the build material transport path.

13. The method of claim 12, further comprising detecting a moisture content in the build material transport path.

14. The method of claim 13, wherein controlling the ratio of the moist air to the ambient air comprises adjusting the ratio in response to the moisture content detected.

15. The method of claim 12, wherein adding moisture with a humidifying element comprises heating the humidifying element.
